(19) United States
(12) Patent Application Publication
(10) Pub. No.: US 2013/0265268 A1
(43) Pub. Date: Oct. 10, 2013

(54) ELECTRONIC DEVICE

(71) Applicant: Panasonic Corporation, Osaka (JP)

(72) Inventors: Ryo OKUMURA, Osaka (JP); Naoto YUMIKI, Osaka (JP); Yusuke ADACHI, Osaka (JP); Akira KOGA, Osaka (JP); Masahiro INATA, Hyogo (JP)

(21) Appl. No.: 13/911,404

(22) Filed: Jun. 6, 2013

Related U.S. Application Data
(63) Continuation of application No. PCT/JP2011/006740, filed on Dec. 1, 2011.

(30) Foreign Application Priority Data
Dec. 13, 2010 (JP) 2010-276538

(51) Int. Cl. G06F 3/01

(52) U.S. Cl. CPC G06F 3/016
USPC 345/173

(57) ABSTRACT

An electronic device 1 includes a display section 12 for displaying an input operation area 52, a touch panel 21 provided on a display surface side of the display section 12 for detecting a touch position touched by a user, a vibration section 23 for vibrating the touch panel 21, and a vibration control section 27 for controlling the vibration section 23 so as to intermittently generate unit vibrations, each of which is composed of a plurality of iterations of a vibration of a predetermined frequency. The vibration control section 27 changes a cycle T on which the unit vibrations are intermittently generated based on a touch position of the user on the touch panel 21.

This is a continuation of International Application No. PCT/JP2011/006740, with an international filing date of Dec. 1, 2011, which claims priority of Japanese Patent Application No. 2010-276538, filed on Dec. 13, 2010, the contents of which are hereby incorporated by reference.

### BACKGROUND

1. Technical Field

The present disclosure relates to an electronic device, which generates a vibration in response to a touch operation by a user.

2. Description of the Related Art

For an electronic device having a touch panel arranged on a display screen, a technique is known in the art for providing an actuator for vibrating the touch panel (e.g., Japanese Laid-Open Patent Publication No. 2005-267080). The electronic device described in Japanese Laid-Open Patent Publication No. 2005-267080 vibrates the display screen based on the display position of icons which are moved and displayed. Thus, the operator is given a tactile sensation in synchronism with an icon display operation.

### SUMMARY

The present disclosure provides an electronic device capable of more reliably giving tactile information to a user.

An electronic device of the present disclosure includes: a display section for displaying an input operation area; a panel to be touched by a user; a vibrating section for vibrating the panel; and a vibration control section for controlling the vibrating section so as to intermittently generate unit vibrations, each of which is composed of a plurality of iterations of a vibration of a predetermined frequency, wherein the vibration control section changes a cycle on which the unit vibrations are intermittently generated based on the touch position of the user on the panel.

According to the present disclosure, unit vibrations, each of which is composed of a plurality of iterations of a vibration of a predetermined frequency, are intermittently generated on the panel, whereby it is possible to more reliably give tactile information to a user. By changing the cycle on which the unit vibrations are intermittently generated based on the touch position of the user on the panel, the user can recognize, based on tactile sensations, how the status of the electronic device changes in response to panel operations.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIGS. 1A and 1B are external perspective views of a digital camera according to an embodiment.

FIG. 2 is a block diagram showing a configuration of a digital camera according to an embodiment.

FIG. 3 is an exploded perspective view of a display section according to an embodiment.

FIG. 4 is an external perspective view of a vibrator according to an embodiment.

FIG. 5A is a diagram showing a vibration pattern in which unit vibrations are intermittently repeated on an intended cycle according to an embodiment.

FIG. 5B is a diagram showing a vibration pattern of the unit vibration itself according to an embodiment.

FIG. 6A is a diagram showing an operation screen when a user is selecting an ISO sensitivity according to an embodiment.

FIG. 6B is a table showing the relationship between the ISO sensitivity and the vibration parameters according to an embodiment.

FIG. 7 is a flow chart showing an operation of a digital camera according to an embodiment.

FIG. 8 is a diagram showing an example of a unit vibration according to an embodiment.

FIG. 9 is a diagram showing an example of a unit vibration according to an embodiment.

FIGS. 10A and 10B are diagrams showing vibration patterns of unit vibrations according to an embodiment.

### DETAILED DESCRIPTION

An embodiment will now be described in detail, referring to the drawings. Note however that unnecessarily detailed descriptions may be omitted. For example, detailed descriptions on what are well known in the art or redundant descriptions on substantially the same configurations may be omitted. This is to prevent the following description from becoming unnecessarily redundant, to make it easier for a person of ordinary skill in the art to understand.

Note that the present inventors provide the accompanying drawings and the following description in order for a person of ordinary skill in the art to sufficiently understand the present disclosure, and they are not intended to limit the subject matter set forth in the claims.

In Japanese Laid-Open Patent Publication No. 2005-267080, the frequency of vibration is changed depending on the display position of an icon. However, since a touch panel provided on an electronic device has an inherent resonance frequency, the amplitude of vibration (the intensity of vibration felt by the user) changes in response to changes in the frequency of vibration. That is, with the configuration of Japanese Laid-Open Patent Publication No. 2005-267080, when the frequency of vibration is changed to a frequency that is outside of the resonance frequency, the amplitude of vibration will decrease, thereby failing to give the user a sufficient tactile sensation.

The present disclosure provides an electronic device capable of more reliably giving tactile information to a user.

### Embodiment 1

<General Configuration of Electronic Device>

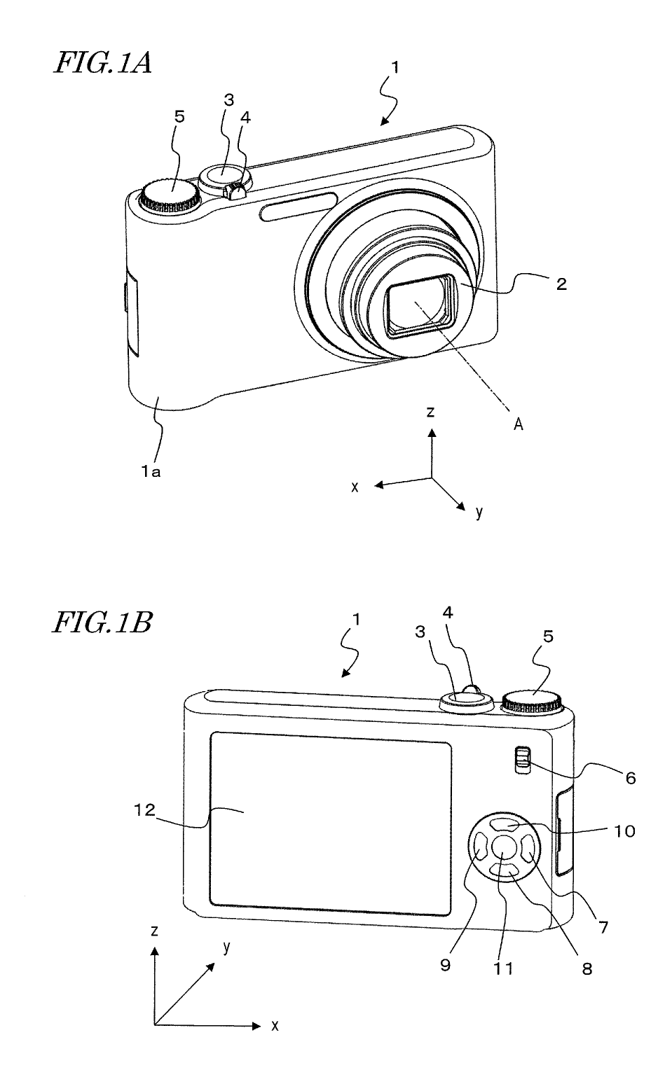

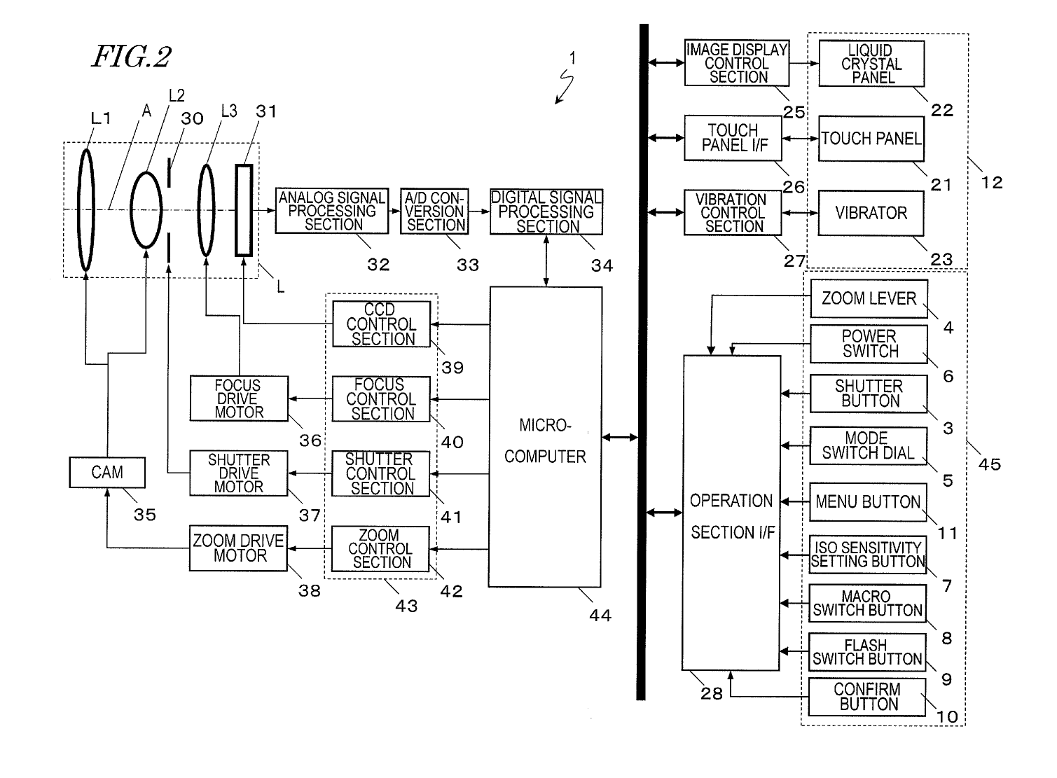

Referring to FIGS. 1 and 2, an electronic device 1 according to the first embodiment will be described. FIGS. 1 and 2 show a digital camera as an example of the electronic device 1.

FIGS. 1A and 1B are external perspective views of the digital camera 1. FIG. 2 is a block diagram showing a configuration of the digital camera 1. As shown in FIG. 1A, the Y-axis direction is defined as a direction along the optical axis A of a lens barrel 2, the X-axis direction as the left-right direction of the digital camera 1, and the Z-axis direction as the up-down direction of the digital camera 1. Note that these directions are not to limit the state of use of the digital camera 1.

As shown in FIG. 1A, the lens barrel 2 is arranged on the front surface of a casing 1a, and a shutter button 3, a zoom lever 4 and a mode switch dial 5 are arranged on the upper surface of the casing 1a. As shown in FIG. 1B, a power switch 6, an ISO sensitivity setting button 7, a macro switch button 8, a flash switch button 9, a confirm button 10, a menu button 11 and a display section 12 are arranged on the back surface of the casing 1a.

The zoom lever 4 is provided around the shutter button 3 so that it can be turned coaxially with respect to the shutter button 3. The power switch 6 is a switch for turning ON/OFF the power of the digital camera 1. The mode switch dial 5 is a dial for switching between various modes of operation such as the still image mode and the replay mode, and a user can switch the mode from one to another by turning the mode switch dial 5. When the still image mode is selected by the mode switch dial 5, the mode can be switched to the still image mode. Moreover, when the replay mode is selected by the mode switch dial 5, the mode can be switched to the replay mode, wherein saved images can be displayed on the display section 12.

As shown in FIG. 2, the digital camera 1 includes an optical system L, a control section 43, a microcomputer 44, an operation section 45, and the display section 12.

The optical system L is an optical system for forming an optical image of an object, and includes a zoom lens L1, a zoom lens L2, a focus lens L3, a shutter 30, and a CCD 31. The optical system L is supported by the lens barrel 2. The microcomputer 44 is a unit for controlling the digital camera 1 as a whole, and is connected to various other units. Note that the control section 43 and the microcomputer 44 may be referred to collectively as a “control section”.

The CCD 31 converts an optical image formed by the optical system L to an electrical image signal. The driving of the CCD 31 is controlled by a CCD control section 39. The image signal output from the CCD 31 is processed successively by an analog signal processing section 32, an A/D conversion section 33, and a digital signal processing section 34. The analog signal processing section 32 performs analog signal processes such as a gamma process on the image signal output from the CCD 31. The A/D conversion section 33 converts the analog signal output from the analog signal processing section 32 to a digital signal. The digital signal processing section 34 performs digital signal processes such as noise reduction or edge enhancement on the image signal, which has been converted by the A/D conversion section 33 to a digital signal.

A focus control section 40 drives a focus drive motor 36 based on a control signal from the microcomputer 44 in order to operate the focus lens L3. The control signal is generated by the microcomputer 44 based on the image signal output from the digital signal processing section 34.

A shutter control section 41 controls a shutter drive motor 37 based on a control signal from the microcomputer 44 in order to operate the shutter 30. The control signal is generated by the microcomputer 44 based on the timing signal obtained by operating the shutter button 3, and the image signal output from the digital signal processing section 34.

A zoom control section 42 drives a zoom drive motor 38 based on a control signal from the microcomputer 44 in order to operate the zoom lens L1 and the zoom lens L2. The control signal is generated by the microcomputer 44 based on a signal obtained by operating the zoom lever 4. The zoom lens L1 and the zoom lens L2 are driven toward the telephoto side when the zoom lever 4 is turned right, and the zoom lens L1 and the zoom lens L2 are driven toward the wide-angle side when the zoom lever 4 is turned left. The zoom drive motor 38 transmits a driving force to the zoom lens L1 and the zoom lens L2 via a cam 35.

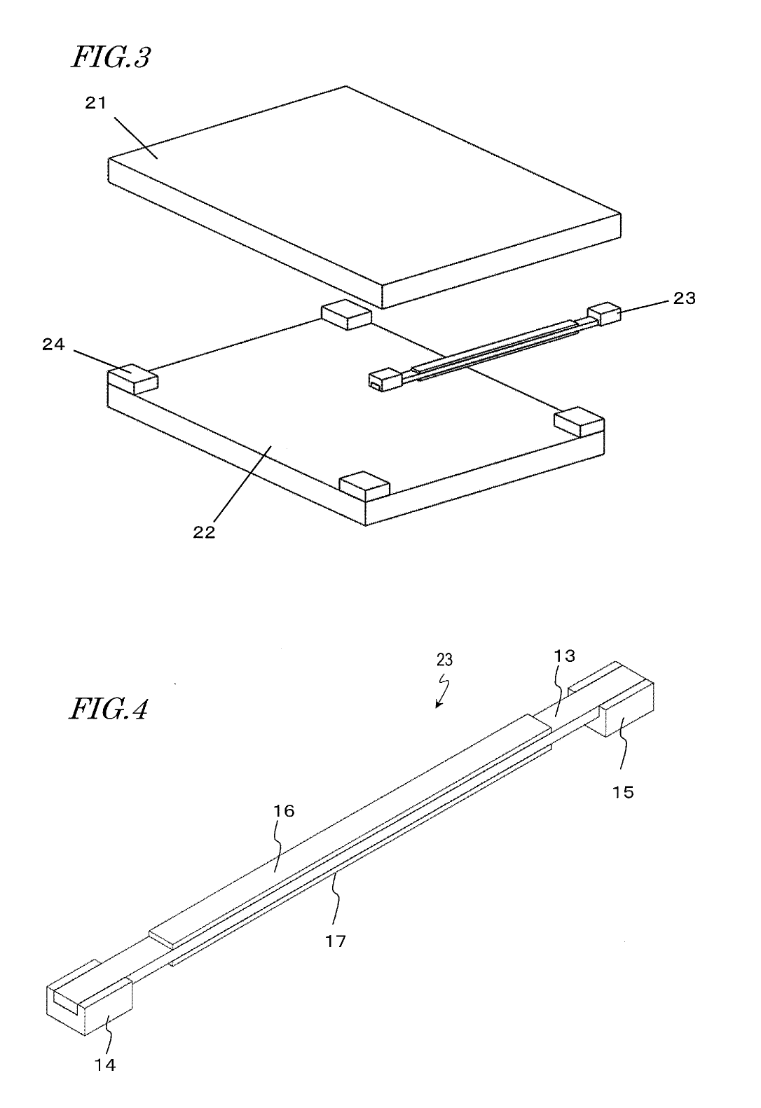

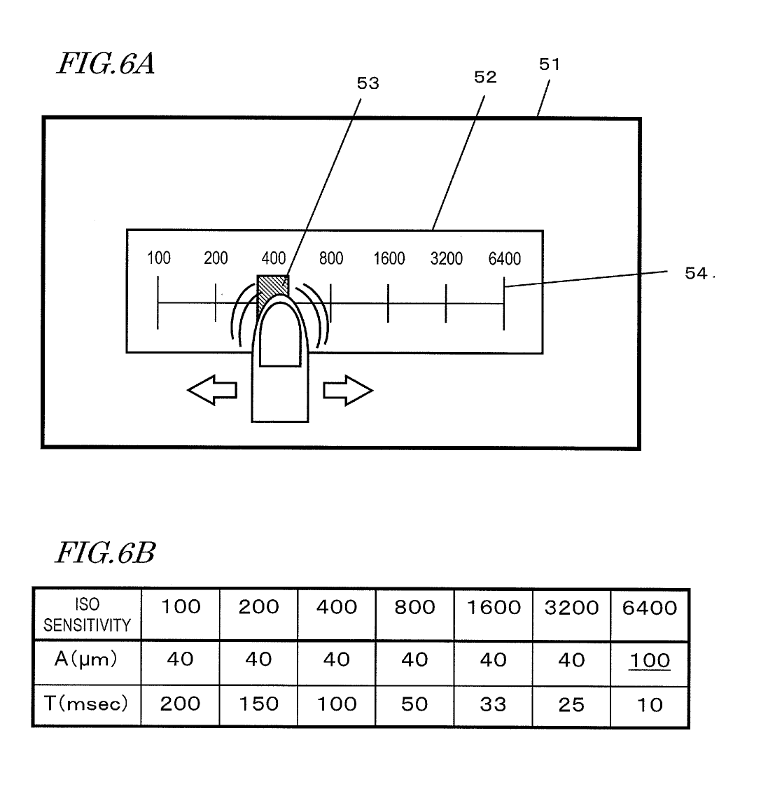

The display section 12 includes a liquid crystal panel 22, a touch panel 21, a vibrator 23, and a cushion 24 (FIG. 3). An image display control section 25 controls what is displayed on the liquid crystal panel 22 based on a control signal generated by the microcomputer 44. The microcomputer 44 is connected to the touch panel 21 via a touch panel I/F 26, and is capable of receiving signals from the touch panel 21. A vibration control section 27 drives the vibrator 23 based on a control signal generated by the microcomputer 44. The vibrator 23 is fixed to the touch panel 21, and the vibration of the vibrator 23 is transmitted to the user via the touch panel. In the present embodiment, the liquid crystal panel 22 is capable of displaying an input operation area 52 (FIG. 6) to be described later. The touch panel 21 is provided on the display surface side of the display section 12, and is arranged so as to cover at least the input operation area 52 of the liquid crystal panel 22.

The operation section 45 includes the shutter button 3, the zoom lever 4, the mode switch dial 5, the power switch 6, the ISO sensitivity setting button 7, the macro switch button 8, the flash switch button 9, the confirm button 10, and the menu button 11. The microcomputer 44 is connected to the operation section 45 via a operation section I/F 28, and is capable of receiving signals from the operation section 45.

The menu button 11 is a button for displaying various menu items on the display section 12. By operating the touch panel 21, a user can select and execute an intended item from among various menu items displayed on the display section 12.

The ISO sensitivity setting button 7 is a button for displaying the ISO sensitivity setting screen on the display section 12. By operating the touch panel 21, a user can select and set an intended ISO sensitivity from the ISO sensitivity setting screen displayed on the display section 12.

The macro switch button 8 is a button for switching between the normal mode and the macro mode in the still image mode.

The flash switch button 9 is a button for switching between the normal mode nd the flash mode in the still image mode.

The confirm button 10 is a button for confirming the execution of a selected item on various menu screens and on the ISO sensitivity setting screen. Note that the execution of a selected item may be confirmed by operating the touch panel 21 or by operating the confirm button 10.

FIG. 3 is an exploded perspective view showing a configuration of the display section 12. The display section 12 includes the touch panel 21, the liquid crystal panel 22, the vibrator 23, and the cushion 24. The vibrator 23 is fixed to the touch panel 21, and is arranged so as not to be in contact with the liquid crystal panel 22 and the cushion 24. The touch panel 21 is fixed to the liquid crystal panel 22 with the cushion 24 interposed therebetween, and is arranged so as not to be in contact with other peripheral members. Therefore, although the vibration of the vibrator 23 is transmitted to the touch panel 21, it is not transmitted to peripheral members such as the liquid crystal panel 22 and the casing 1a. The touch panel 21 may be operated with a finger of a user or with a tool such as a touch pen. Note that the touch position detection method of the touch panel 21 may be pressure-sensitive or electrostatic.

FIG. 4 is an external perspective view of the vibrator 23. The vibrator 23 includes a vibrating plate 13, spacers 14 and 15, and piezoelectric elements 16 and 17. The vibrating plate 13 is fixed to the touch panel 21 with the spacers 14 and 15 interposed therebetween. The piezoelectric elements 16 and 17 are fixed to opposite surfaces of the vibrating plate. In the present embodiment, the vibrating plate 13 and the piezoelectric elements 16 and 17 are provided in a so-called bimorph configuration. Thus, the vibrating plate 13 can be vibrated by differentially applying AC voltage to the piezoelectric elements 16 and 17.

Note that one of the piezoelectric elements 16 and 17 may be provided directly on the touch panel 21 without the spacers 14 and 15 or the vibrating plate 13 interposed therebetween. While the vibrator 23 has been described as an example of the vibrating section for vibrating the touch panel 21, the vibrating section may be a thin-film piezoelectric member formed on the touch panel 21 by a method such as sputtering.

<Vibration Pattern>

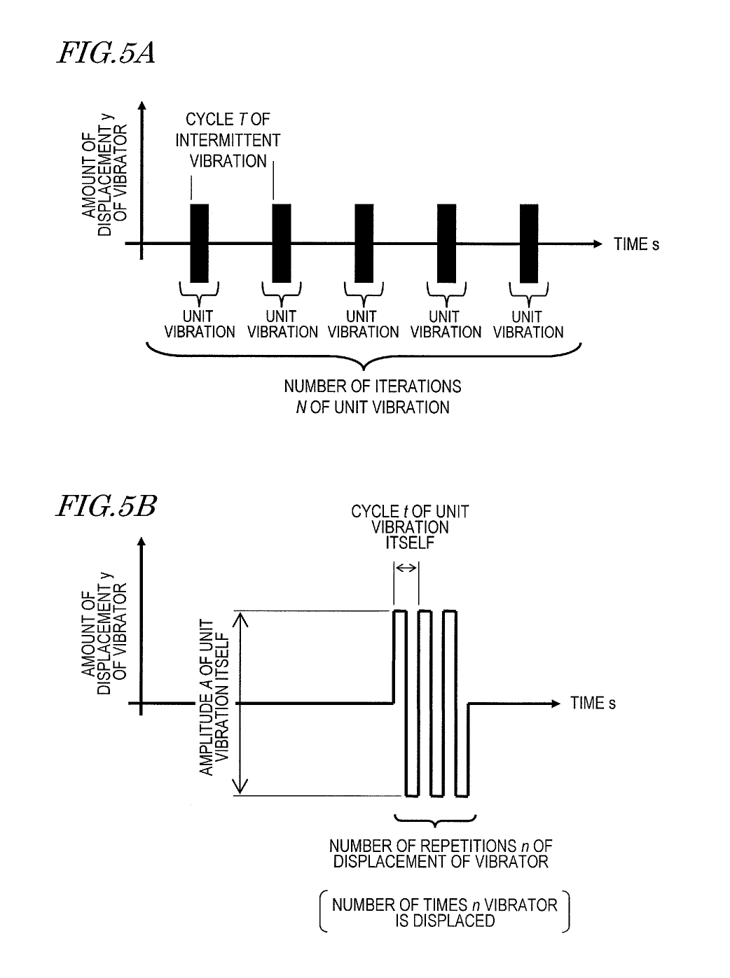

Next, referring to FIG. 5, an example of a vibration pattern of the vibrator 23 will be described. FIG. 5A is a diagram showing a vibration pattern in which unit vibrations are intermittently repeated on an intended cycle, and FIG. 5B is a diagram showing a vibration pattern of the unit vibration itself.

The vertical axis of FIG. 5A is the amount of displacement y of the vibrator 23, and the horizontal axis is the time s. FIG. 5A shows how the unit vibration occurs intermittently in N iterations on a cycle T. The vertical axis of FIG. 5B is the amount of displacement y of the vibrator 23, and the horizontal axis is the time s. FIG. 5B shows how the displacement of the vibrator 23 occurs successively in n iterations on a cycle t. Herein, “N” and “n” are each an integer or a decimal greater than zero. Moreover, “T” has a larger value than “t”.

First, the vibrator 23 generates a unit vibration as shown in FIG. 5B. Herein, a “unit vibration” means a vibration composed of vibrations of a predetermined frequency. For Example, a unit vibration is composed of a plurality of vibrations of a predetermined frequency. As shown in FIG. 5A, the vibrator 23 generates unit vibrations intermittently. The vibration generated intermittently will be referred to also as an “intermittent vibration”.

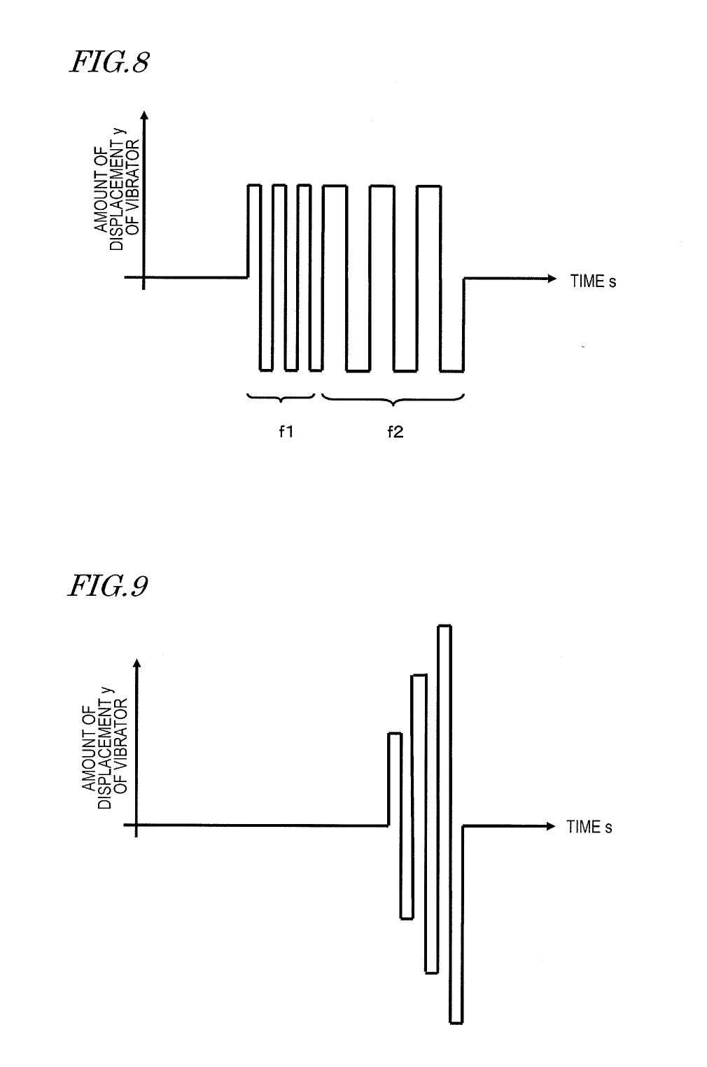

Note that while FIG. 5A shows an example of a unit vibration, the vibration pattern of the unit vibration is not limited thereto. For example, it may be composed of a combination of vibrations of a plurality of frequencies, as shown in FIG. 8. Specifically, the unit vibration shown in FIG. 8 is a combination of a vibration of a frequency f1 and a vibration of a frequency f2. By generating such a unit vibration, it is possible to increase the variety of vibrations of the touch panel as compared with a case where the unit vibration is composed only of vibrations of a single frequency.

As shown in FIG. 9, the vibration pattern of a unit vibration may be composed of vibrations having a predetermined frequency and varying amplitudes. Then, it is possible to increase the variety of variations of the touch panel as compared with unit vibrations all of a uniform amplitude.

In the present embodiment, the frequency of the unit vibration is set to be close to the resonance frequency of the touch panel 21 or the vibrator 23. Thus, it is easier to transmit tactile information, i.e., a vibration, to the user. Note that it is said that a human is more sensitive to tactile sensations at a frequency of 200 to 300 Hz. For Example, the resonance frequency of the touch panel 21, carried on the electronic device 1, is set within a range of 200 to 300 Hz, and the frequency of the unit vibration (1/t) is also set within this range.

Then, in the present embodiment, the cycle T of the intermittent vibration and the number of iterations N of the unit vibration are changed depending on the touch position of the user while the frequency of the unit vibration is not changed but is kept constant. Even if the cycle T of the intermittent vibration and the number of iterations N of the unit vibration are changed, the amplitude of the unit vibration will not decrease and the touch panel 21 can be vibrated sufficiently because the frequency of the unit vibration is kept within the range of the resonance frequency. The tactile information can be changed by changing the cycle T of the intermittent vibration and the number of iterations N of the unit vibration. That is, it is possible to vary the tactile information while sufficiently vibrating the touch panel 21.

<Method of Touch Operation by User>

Referring to FIG. 6, an ISO sensitivity setting screen 51 and the method for driving the vibrator 23 when setting the ISO sensitivity will be described. FIG. 6A is a diagram showing an operation screen when a user is selecting a position of a 400 ISO sensitivity. FIG. 6B is a table showing the relationship between the ISO sensitivity and the vibration parameters.

As shown in FIG. 6A, the ISO sensitivity setting screen 51 is displayed on the display section 12. The ISO sensitivity setting screen 51 includes an operation area 52 for changing the ISO sensitivity. The operation area 52 is an example of the input operation area.

A user can change the ISO sensitivity by sliding a pointer 53 along a scale 54. In other words, the ISO sensitivity is changed in accordance with a continuous change of the touch position of the user. The ISO sensitivity typically takes discrete values such as “100, 200, 400, . . . ”, and these values are displayed on the scale 54. While the ISO sensitivity is changed in the present embodiment, a user may be allowed to change other parameters, such as the white balance and the exposure adjustment. In such a case, a screen for operating a parameter that takes continuous values, instead of a parameter that takes discrete values such as the ISO sensitivity, may be displayed on the display section 12.

The method of operation by the user will now be described.

First, the ISO sensitivity setting screen 51 is displayed on the display section 12. The pointer 53 is displayed at the position of the previously-selected ISO sensitivity, e.g., at the position of “400”. A user can change the ISO sensitivity by touching and sliding the pointer 53 left and right.

Alternatively, the user can change the ISO sensitivity by directly touching the position of the intended ISO sensitivity without sliding the pointer 53. In that case, the pointer 53 is displayed at the position representing the ISO sensitivity closest to the touch position of the user.

The microcomputer 44 gives vibration information based on the position of the pointer 53 to the vibration control section 27. The vibration control section 27 vibrates the vibrator 23 based on the vibration information. The vibration control section 27 is capable of generating a different vibration pattern depending on the position of the scale 54 as shown in FIG. 6B. In the present embodiment, the cycle T of the intermittent vibration is set to larger values for lower ISO sensitivities, and the cycle T of the intermittent vibration is set to smaller values for higher ISO sensitivities. Since the vibration pattern changes in accordance with the touch position of the user, the user can obtain a tactile sensation in response to an operation of changing the ISO sensitivity.

When the pointer 53 reaches the highest value on the scale 54 (the position of a 6400 ISO sensitivity in the present embodiment), the vibration control section 27 vibrates the vibrator 23 so that the amplitude A of vibration is higher than that for other positions. Generally, the image quality can possibly deteriorate if the ISO sensitivity becomes too high. In view of this, the present embodiment employs such settings that the amplitude A of vibration is increased when the pointer 53 reaches the highest value on the scale 54. Thus, the user can know that the ISO sensitivity has been set to the highest value.

During a touch operation by a user, the finger of the user may move out of the operation area 52. For example, when the user is sliding the pointer 53 while the finger of the user is in contact with the touch panel 21, the finger may continuously move from inside to outside the operation area 52. In such cases, different vibration patterns may be generated between inside and outside of the operation area 52. Alternatively, the vibrator 23 may not be vibrated while the finger of the user is touching outside the operation area 52. By generating different vibration patterns between inside and outside of the operation area 52, the user can notice that the finger has moved out of the operation area 52. When the finger of the user is touching outside the operation area 52, a vibration of a predetermined duration (e.g., about 1 sec) may be generated with the amplitude of vibration being larger than that while the finger is inside the operation area 52. Alternatively, the cycle T of the intermittent vibration may be varied between inside and outside of the operation area 52.

During a touch operation by a user, the finger of the user may move from outside to inside the operation area 52. Similarly, the generated vibration pattern can be varied between outside and inside of the operation area 52.

By varying the vibration pattern in accordance with the touch panel operation, the user can recognize changes in the touch position or the status of the electronic device based on tactile sensations.

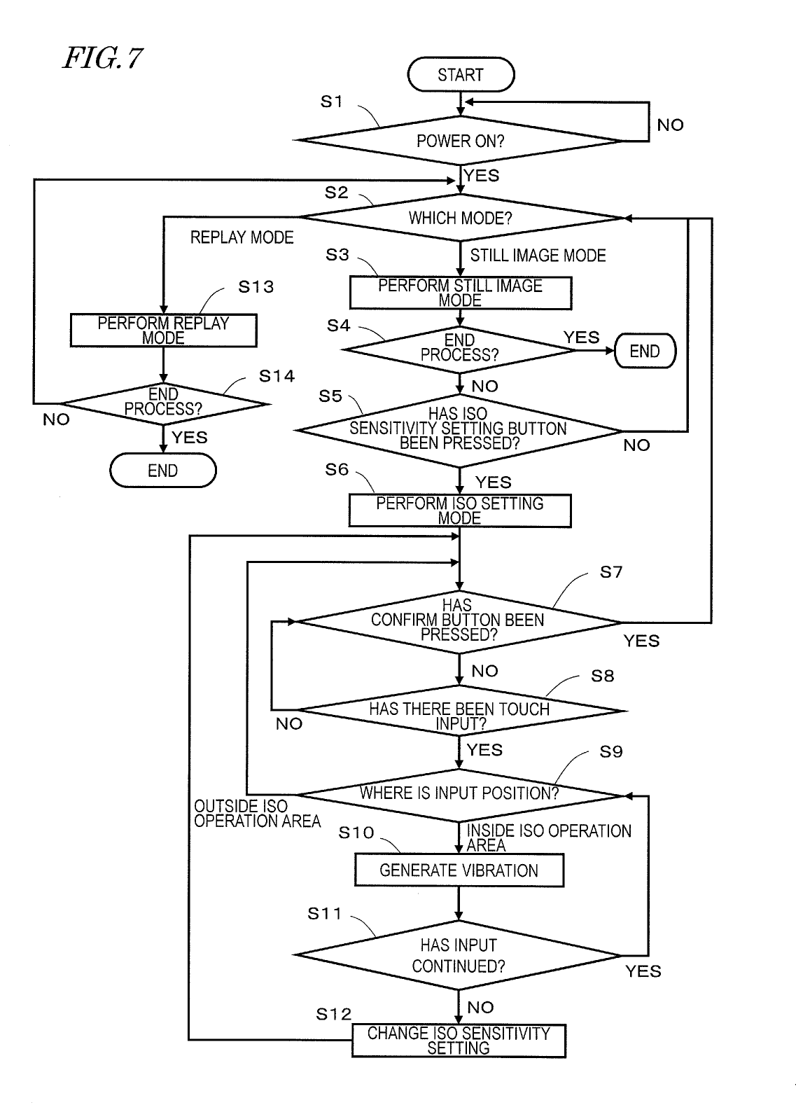

FIG. 7 is a flow chart showing the flow of the information process of the digital camera 1 of the present embodiment. First, the user turns on the power of the digital camera 1 (step S1). The user can switch between the still image mode and the replay mode by turning the mode switch dial 5 (step S2). When the still image mode is selected, the still image mode of the digital camera 1 is performed, where the user is allowed to take still images (step S3). When the replay mode is selected, the replay mode of the digital camera 1 is performed, where saved images, etc., are displayed on the display section 12 (step S13). Then, the process transitions to step S14, where the microcomputer 44 determines whether or not to end the process. For example, the process may end by detecting power-off information. If power-off information is not detected, the process returns to step S2, where a mode is selected.

In step S3, if the still image mode is performed, the process transitions to step S4, where the microcomputer 44 determines whether or not to end the process. For example, the process may end when power-off information is detected. If power-off information is not detected, the process proceeds to step S5, where the microcomputer 44 determines whether the user has pressed the ISO sensitivity setting button 7. If the ISO sensitivity setting button 7 has been pressed, the digital camera 1 performs the ISO sensitivity setting mode (step S6). If the ISO sensitivity setting mode is performed, an operation screen shown in FIG. 6A is displayed on the display section 12.

Next, the microcomputer 44 determines whether the user has pressed the confirm button 10 (step S7). The user can end the ISO sensitivity setting mode by pressing the confirm button 10. If the confirm button 10 has not been pressed, the microcomputer 44 determines whether the user has made a touch input (step S8).

If the touch input is detected, the position at which the user has made the touch input is detected (step S9). If the position of the touch input of the user is outside the operation area 52, the process returns to step S7. If the position of the touch input of the user is inside the operation area 52, the vibration control section 27 vibrates the vibrator 23 (step S10).

Then, the microcomputer 44 determines whether the touch input by the user has continued (step S11). If the user is sliding the pointer 53, the microcomputer 44 determines that the touch input has continued, and the process returns to step S9, where the touch input position is detected. Then, the vibration control section 27 vibrates the vibrator 23 in accordance with the touch input position.

When a user slides the pointer 53 and stops the pointer 53 at the position of an intended ISO sensitivity, the ISO sensitivity setting is changed (step S12), and the process returns to step S7. Then, if the user presses the confirm button 10, the ISO sensitivity setting mode ends.

<Summary>

The digital camera 1 of the present embodiment includes the display section 12, the touch panel 21, the vibrator 23, and the vibration control section 27. The display section 12 displays the operation area 52 for changing the ISO sensitivity. The touch panel 21 is provided so as to at least cover the operation area 52 displayed on the display section 12. The touch panel 21 detects a touch position touched by a user. The vibrator 23 vibrates the touch panel 21. The vibration control section 27 controls the vibration pattern of the vibrator 23. The vibration control section 27 controls the vibrator 23 so as to intermittently generate unit vibrations, each of which is composed of vibrations of a predetermined frequency.

With such a configuration, the user can reliably receive tactile information since it is possible to prevent the vibration amplitude from attenuating because of the vibration frequency being away from the resonance frequency of members of the digital camera 1.

The vibration control section 27 changes the vibration pattern of the vibrator 23 depending on the touch position of the user on the touch panel 21. With such a configuration, it is possible to give the user various tactile information depending on the touch position of the user.

The vibration control section 27 controls the vibrator 23 so that the vibrator 23 vibrates when the touch position of the user is inside the operation area 52, and the vibrator 23 does not vibrate when the touch position of the user is out of the operation area 52. With such a configuration, it is possible to give the user tactile information indicating whether the user is touching inside the operation area 52 or outside the operation area 52.

The vibration control section 27 also changes the vibration pattern when the touch position of the user continuously changes from inside to outside the operation area 52. With such a configuration, it is possible to give the user tactile information indicating that the touch position has moved out of the operation area.

The vibration control section 27 also changes the vibration pattern when the touch position of the user continuously changes from outside to inside the operation area 52. With such a configuration, it is possible to give the user tactile information indicating that the touch position has moved into the operation area.

The frequency of the unit vibration is set to 200 to 300 Hz. With such a configuration, it is possible to more reliably give tactile information to a user.

### Embodiment 2

Embodiment 1 is directed to an example where a predetermined unit vibration is used. In contrast, in Embodiment 2, a vibration of an intended frequency is selected from among a plurality of predetermined frequencies, and the touch panel 21 is vibrated using the selected unit vibration.

The digital camera 1 of Embodiment 2 has a similar configuration to that of the digital camera 1 of Embodiment 1, and therefore FIG. 2 will be used again in the description below.

In Embodiment 2, the microcomputer 44 functions also as a selection section for selecting a vibration of an intended frequency from among a plurality of predetermined frequencies. Then, the vibration control section 27 controls the vibrator 23 so as to intermittently generate unit vibrations, each of which is composed of vibrations of the frequency selected by the microcomputer 44.

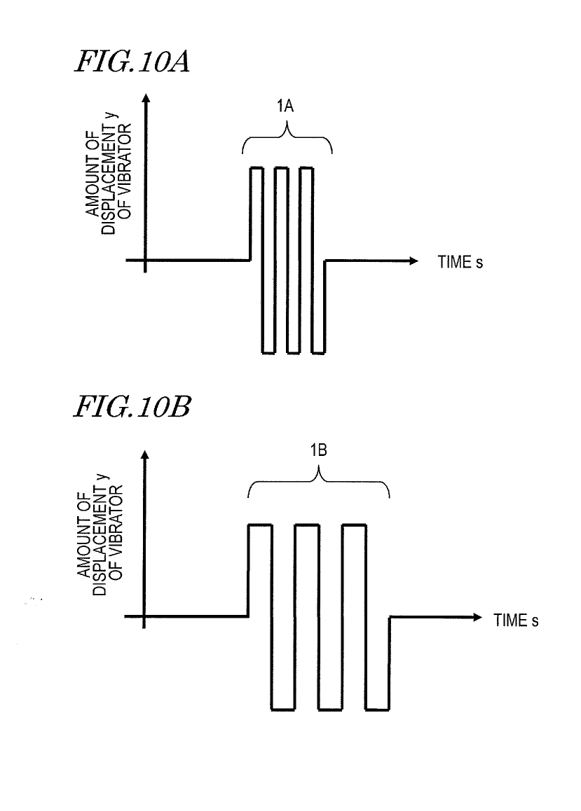

For example, the microcomputer 44 selects one of the unit vibration 1A shown in FIG. 10A and the unit vibration 1B shown in FIG. 10B.

Thus, since the microcomputer 44 selects a vibration of an intended frequency from among a plurality of predetermined frequencies, it is possible to vibrate the touch panel 21 depending on the circumstances, as compared with a case where a predetermined unit vibration is fixedly used.

The microcomputer 44 may select a vibration of an intended frequency from among a plurality of predetermined frequencies depending on the touch position of the user on the touch panel 21. Then, it is possible to widen the variety of how the user is notified of the touch position by way of vibrations.

Note that the operation of controlling the vibration according to the embodiments may be implemented by means of hardware or software. A program implementing such a vibration control operation is stored, for example, in an internal memory of the microcomputer 44 or in a storage medium provided separately from the microcomputer 44. Such a computer program may be installed onto the electronic device 1 from a storage medium (an optical disc, a semiconductor memory, etc.) storing the computer program, or may be downloaded via a telecommunications network such as the Internet.

### Alternative Embodiments

While Embodiments 1 and 2 have been described above as examples of embodiments, the embodiments are not limited thereto. Alternative embodiments will be described below.

While Embodiments 1 and 2 are each directed to a digital camera as an example of the electronic device, the electronic device is not limited thereto. For example, the present disclosure is applicable to other electronic devices having a touch panel thereon, e.g., mobile telephones, PDAs, game devices, car navigations, ATMs, etc.

While Embodiments 1 and 2 are each directed to a case where the liquid crystal panel 22 is used as the display section, the embodiments are not limited thereto. For example, an organic EL display, etc., may be used.

While Embodiments 1 and 2 each provide, as the input operation area 52, the operation area for the ISO sensitivity setting of a camera, the embodiments are not limited thereto. For example, it may be an operation area for inputting telephone numbers, or an operation area for inputting text. In other words, it may be any area on which user operations are received.

While Embodiments 1 and 2 are each directed to an example where the touch panel 21 covers the entire display surface of the liquid crystal panel 22, the embodiments are not limited thereto. For example, the touch panel function may be provided only for a central portion of the display surface, with a peripheral portion left uncovered by any portion having the touch panel function. In other words, it may be any configuration as long as at least the input operation area 52 of the display section 12 is covered.

While Embodiments 1 and 2 are each directed to an example where a piezoelectric element is used in the vibrator 23, the embodiments are not limited thereto. For example, the vibrator may be one that uses an electromagnetic force, such as an eccentric motor. In other words, it may be any vibrator that is capable of generating an intended vibration pattern.

While the vibration control section 27 intermittently generates unit vibrations with periodicity in Embodiments 1 and 2, the embodiments are not limited thereto. For example, the vibration control section 27 may generate unit vibrations intermittently but without periodicity. Then, it is possible to widen the variety of vibration patterns with which a plurality of unit vibrations are generated. In other words, the vibration control section 27 may be any vibration control section as long as it controls the vibrator 23 so as to intermittently generate unit vibrations, each of which is composed of vibrations of a predetermined frequency.

While the touch panel 21 and the liquid crystal panel 22 are provided separately in Embodiments 1 and 2, the embodiments are not limited thereto. For example, the touch panel 21 may be bonded to the liquid crystal panel 22. Alternatively, the liquid crystal panel 22 may be provided with the function of detecting touch positions. In other words, it may be any configuration as long as touch positions can be detected.

While the touch panel 21 is vibrated in Embodiments 1 and 2, the embodiments are not limited thereto. For example, in a case where a cover glass is arranged on the outside of the touch panel 21, the cover glass may be vibrated. In other words, it may be any configuration as long as it is possible to vibrate a member that is in contact with the user.

In one embodiment, an electronic device 1 includes: a display section 12 for displaying an input operation area 52; a touch panel 21 provided on a display surface side of the display section 12 for detecting a touch position touched by a user; a vibrating section 23 for vibrating the touch panel 21; and a vibration control section 27 for controlling the vibrating section 23 so as to intermittently generate unit vibrations, each of which is composed of a plurality of iterations of a vibration of a predetermined frequency, wherein the vibration control section 27 changes a cycle on which the unit vibrations are intermittently generated based on the touch position of the user on the touch panel 21.

In one embodiment, the unit vibration includes a vibration of a resonance frequency of the touch panel 21.

In one embodiment, the unit vibration includes a vibration of the resonance frequency even if the cycle on which the unit vibrations are intermittently generated changes.

In one embodiment, the cycle on which the unit vibrations are intermittently generated is longer than a cycle of a plurality of vibrations of the unit vibration.

In one embodiment, the vibration control section 27 vibrates the vibrating section 23 when the touch position of the user is inside the input operation area 52; and the vibration control section 27 does not vibrate the vibrating section 23 when the touch position of the user is outside the input operation area 52.

In one embodiment, the vibration control section 27 changes the cycle on which the unit vibrations are intermittently generated when the touch position of the user continuously changes from inside to outside the input operation area 52.

In one embodiment, the vibration control section 27 changes the cycle on which the unit vibrations are intermittently generated when the touch position of the user continuously changes from outside to inside the input operation area 52.

In one embodiment, the frequency of the unit vibration is 200 to 300 Hz.

In one embodiment, the unit vibration is composed of vibrations of a single predetermined frequency.

In one embodiment, the unit vibration is composed of a combination of vibrations of a plurality of different predetermined frequencies.

In one embodiment, the vibrations of the plurality of different predetermined frequencies have different amplitudes.

In one embodiment, the electronic device 1 further includes a selection section 44 for selecting a particular frequency from among a plurality of different predetermined frequencies, wherein the vibration control section 27 controls the vibrating section 23 so as to intermittently generate unit vibrations, each of which is composed of vibrations of the frequency selected by the selection section 44.

In one embodiment, the selection section 44 changes the frequency to be selected based on the touch position of the user on the touch panel 21.

In one embodiment, a program of the present disclosure is a program for instructing an electronic device 1 to perform an operation of vibrating a touch panel 21, the program instructing the electronic device 1 to perform the steps of: controlling a vibrating section 23 for vibrating the touch panel 21 so as to intermittently generate unit vibrations, each of which is composed of a plurality of iterations of a vibration of a predetermined frequency; and changing the cycle on which the unit vibrations are intermittently generated based on a touch position of the user on the touch panel 21.

According to the present disclosure, unit vibrations, each of which is composed of a plurality of iterations of a vibration of a predetermined frequency, are intermittently generated on the touch panel 21, whereby it is possible to more reliably give tactile information to a user. By changing the cycle on which the unit vibrations are intermittently generated based on the touch position of the user on the touch panel 21, the user can recognize, based on tactile sensations, how the status of the electronic device 1 changes in response to touch panel 21 operations.

In one embodiment, the unit vibration includes a vibration of the resonance frequency of the touch panel 21, whereby it is possible to suppress the decrease in the vibration amplitude even when the vibration pattern is changed, and it is possible to more reliably give tactile information to a user.

Embodiments have been described above as an illustration of the technique of the present disclosure. The accompanying drawings and the detailed description are provided for this purpose. Thus, elements appearing in the accompanying drawings and the detailed description include not only those that are essential to solving the technical problems set forth herein, but also those that are not essential to solving the technical problems but are merely used to illustrate the technique disclosed herein. Therefore, those non-essential elements should not immediately be taken as being essential for the reason that they appear in the accompanying drawings and/or in the detailed description.

The embodiments above are for illustrating the technique disclosed herein, and various changes, replacements, additions, omissions, etc., can be made without departing from the scope defined by the claims and equivalents thereto.

The present disclosure is useful in electronic devices, etc., which generate vibrations in response to touch operations by the user.

What is claimed is:

1. An electronic device comprising:
a display section for displaying an input operation area;
a panel to be touched by a user;
a vibrating section for vibrating the panel; and
a vibration control section for controlling the vibrating section so as to intermittently generate unit vibrations, each of which is composed of a plurality of iterations of a vibration of a predetermined frequency,
wherein the vibration control section changes a cycle on which the unit vibrations are intermittently generated based on a touch position of the user on the panel.

2. The electronic device according to claim 1, wherein the unit vibration includes a vibration of a resonance frequency of the panel.

3. The electronic device according to claim 2, wherein the unit vibration includes a vibration of the resonance frequency even if the cycle on which the unit vibrations are intermittently generated changes.

4. The electronic device according to claim 1, wherein the cycle on which the unit vibrations are intermittently generated is longer than a cycle of a plurality of vibrations of the unit vibration.

5. The electronic device according to claim 1, wherein:
the vibration control section vibrates the vibrating section when the touch position of the user is inside the input operation area; and
the vibration control section does not vibrate the vibrating section when the touch position of the user is outside the input operation area.

6. The electronic device according to claim 1, wherein the vibration control section changes the cycle on which the unit vibrations are intermittently generated when the touch position of the user continuously changes from inside to outside the input operation area.

7. The electronic device according to claim 1, wherein the vibration control section changes the cycle on which the unit vibrations are intermittently generated when the touch position of the user continuously changes from outside to inside the input operation area.

8. The electronic device according to claim 1, wherein the frequency of the unit vibration is 200 to 300 Hz.

9. The electronic device according to claim 1, wherein the unit vibration is composed of vibrations of a single predetermined frequency.

10. The electronic device according to claim 1, wherein the unit vibration is composed of a combination of vibrations of a plurality of different predetermined frequencies.

11. The electronic device according to claim 10, wherein the vibrations of the plurality of different predetermined frequencies have different amplitudes.

12. The electronic device according to claim 1, further comprising a selection section for selecting a particular frequency from among a plurality of different predetermined frequencies,
wherein the vibration control section controls the vibrating section so as to intermittently generate unit vibrations, each of which is composed of vibrations of the frequency selected by the selection section.

13. The electronic device according to claim 12, wherein the selection section changes the frequency to be selected based on the touch position of the user on the panel.

14. A program for instructing an electronic device to perform an operation of vibrating a panel to be touched by a user, the program instructing the electronic device to perform the steps of:
controlling a vibrating section for vibrating the panel so as to intermittently generate unit vibrations, each of which is composed of a plurality of iterations of a vibration of a predetermined frequency; and
changing the cycle on which the unit vibrations are intermittently generated based on a touch position of the user on the panel.
